(19) United States
(12) Patent Application Publication
(10) Pub. No.: US 2011/0182178 A1
(43) Pub. Date: Jul. 28, 2011

(54) Randomization Management For Carrier Sensing Multiple Access with Collision Avoidance (CSMA-CA)

(75) Inventors: Shu DU, Richardson, TX (US); Susan YIM, Plano, TX (US); Xiaolin LU, Plano, TX (US); Badri VARADARAJAN, Dallas, TX (US)

(73) Assignee: TEXAS INSTRUMENTS INCORPORATED, Dallas, TX (US)

(21) Appl. No.: 13/009,028

(22) Filed: Jan. 19, 2011

Related U.S. Application Data
(60) Provisional application No. 61/299,222, filed on Jan. 28, 2010.
(60) Provisional application No. 61/299,226, filed on Jan. 28, 2010.
(60) Provisional application No. 61/310,569, filed on Mar. 4, 2010.

(51) Int. Cl. H04L 12/26

(52) U.S. Cl. 370/230

(57) ABSTRACT

In at least some embodiments, a communication device includes a transceiver with Carrier Sensing Multiple Access with Collision Avoidance (CSMA-CA) logic. The CSMA-CA logic provides dynamic randomization management for a contention window size.

### CROSS-REFERENCE TO RELATED APPLICATION

The present application claims priority to U.S. Provisional Patent Application to U.S. Provisional Patent Application No. 61/299,222, filed on Jan. 28, 2010 (Attorney Docket No. TI-69022PS); U.S. Provisional Patent Application No. 61/299,226, filed on Jan. 28, 2010 (Attorney Docket No. TI-69021PS); and U.S. Provisional Patent Application No. 61/310,569, filed on Mar. 4, 2010 (Attorney Docket No. TI-69161PS); all of which are hereby incorporated herein by reference.

### BACKGROUND

Smart grid technology refers to ongoing improvements for the transmission and distribution of electricity from points of generation to consumers. A key component in a smart grid network is the so-called “smart-metering” network. In a typical smart-metering network, electricity (or other utility) meters located at a residency or other edifice are able to transmit the real-time meter readings through power lines back to the power concentrators and provide valuable real-time electricity control and billing information for the electricity provider. Due to power efficiency considerations and severe noise in power lines, direct transmission of metering information through power lines has limited scopes. Therefore, a typical smart metering network has a tree-like topology, including: 1) a data concentrator that serves as the root node in the tree (also called as base node, BN); 2) metering devices that act as leaf nodes (also called service nodes, SN) in the tree and will send their metering readings back to the BN; and 3) metering nodes that are selected to be switching nodes (SW) and act as the branch nodes in the tree. The switching nodes operate to relay the data traffic to the further hops for communication pairs (e.g., a SN and a BN) beyond the direct communication reach.

Powerline-Related Intelligent Metering Evolution (PRIME) is a European standard of smart-metering network. A PRIME network is composed of a tree as mentioned previously. In a PRIME network, the MAC function enables the base node (BN), as well as the switch nodes, to send out beacons periodically. The beacons also help all the SNs in the network synchronize their clocks and virtually chop the time domain into discrete time frames, as shown in FIG. 1 which is a diagram illustrative of a structure of a PRIME frame. Each PRIME frame is further divided into three segments: 1) a Beacon slots segment; 2) a Shared Contention Period (SCP); and 3) a Contention Free Period (CFP). During the Beacon slots segment, BN and switch nodes will send their beacons. During CFP, only dedicated communication pairs are allowed to communicate. During SCP, any station is allowed to transmit based on a CSMA-CA (Carrier Sensing Multiple Access with Collision Avoidance) algorithm.

When there are multiple nodes in a network, they all attempt to access the medium during the SCP. If multiple nodes have packets with the same priority, the random backoffs generated for the same priority packets all fall in a narrow range, resulting in a high probability of collisions. For example, if several nodes need to send registration or keep-alive messages, which are top priority packets, the initial backoff window macSCPRBO (defined as a number of discrete small time slots) can only be selected from slot 0 to slot 2. Clearly, if there are more than three nodes, at least two nodes will select the same value of macSCPRBO and will transmit simultaneously and collide. This kind of collision and consequent performance drops have been observed in both lab tests and simulations. As smart metering applications become more important, the issue of how to handle network scalability is one of the key challenges for the smart metering network design.

### SUMMARY

In at least some embodiments, a communication device includes a transceiver with Carrier Sensing Multiple Access with Collision Avoidance (CSMA-CA) logic. The CSMA-CA logic provides dynamic randomization management for a contention window size.

In at least some embodiments, a computer-readable storage medium stores instructions that, when executed, determine a network congestion status. The instructions also cause a processor to dynamically manage randomization of a contention window size for CSMA-CA based on the determined network congestion status.

In at least some embodiments, a method for CSMA-CA includes determining a network congestion status. The method also includes adjusting a range for randomization of a contention window size for CSMA-CA based on the determined network congestion status.

### BRIEF DESCRIPTION OF THE DRAWINGS

For a detailed description of exemplary embodiments of the invention, reference will now be made to the accompanying drawings in which:

FIG. 1 shows the structure of a Powerline-Related Intelligent Metering Evolution (PRIME) frame;

FIG. 2 shows a flowchart for a PRIME Carrier Sensing Multiple Access with Collision Avoidance (CSMA-CA) algorithm;

FIG. 3 shows a communication device in accordance with an embodiment of the disclosure;

FIG. 4 shows a CSMA-CA algorithm for increasing a range for randomization of a contention window size in accordance with an embodiment of the disclosure; and

FIG. 5 shows a CSMA-CA algorithm for reducing dropped packets and withholding the increase of the range of randomization for contention window size; and

FIG. 6 shows a computer system for implementing CSMA-CA algorithms in accordance with embodiments of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are methods and systems for modified CSMA-CA techniques. The disclosed CSMA-CA techniques were developed for use in a Powerline-Related Intelligent Metering Evolution (PRIME) networks, but are not necessarily limited to PRIME networks. To summarize, the disclosed CSMA-CA techniques manage the conditions for increasing or withholding the range of randomization for a contention window size, for randomizing a channel sense delay and/or for modifying the CSMA-CA failure notification criteria. The CSMA-CA techniques may be dynamically adjusted by one or more nodes of a network in response to a determined network congestion status (e.g., the number of nodes present in a network and/or traffic levels)

In collision avoidance on a wire, the transceiver has the ability to listen while transmitting and so to detect collisions. Further, with a wire, all transmissions have approximately the same strength. In contrast, even if a radio node could listen on the channel while transmitting, the strength of its own transmissions would mask all other signals on the air. In such case, detection of collisions (like with Ethernet) is not possible and collisions are avoided as much as possible.

A communication device that implements Carrier Sensing Multiple Access with Collision Avoidance (CSMA-CA) starts by listening on the channel. If the channel is found to be idle, the communication device sends the first packet in the transmit queue. If the channel is busy (due to another node transmission or interference), the communication device awaits the end of the current transmission and then starts the contention (waiting a random amount of time). When the contention timer expires, if the channel is still idle, the communication device sends the packet. The other nodes just wait for the next contention (at the end of this packet). Since the contention length is a random length and is done for every packet transmission, each node is given an equal chance to access the channel. Due to collisions being undetected via radio and radio devices needing time to switch from receive to transmit, a contention is usually slotted (a transmission may start only at the beginning of a slot (e.g., 50 μs in IEEE 802.11 FH and 20 μs in IEEE 802.11 DS). This technique makes the average contention delay larger, but reduces significantly the number of collisions.

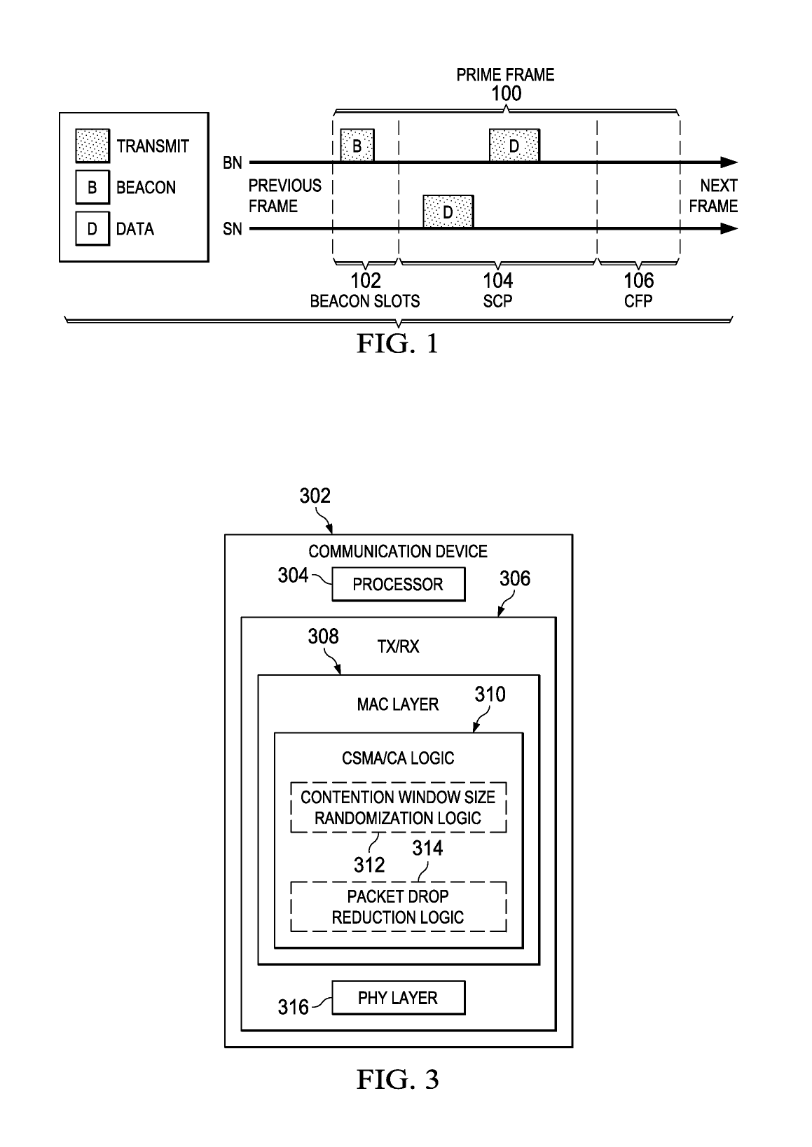

FIG. 1 shows the structure of a Powerline-Related Intelligent Metering Evolution (PRIME) frame 100. As shown, the PRIME frame 100 comprises beacon slots 102, a Shared Contention Period (SCP) 104, and a Contention-Free Period (CFP) 106. The PRIME frame 100 describes a time frame organization during which Service Nodes (SN) and a Base Node (BN) of a subnetwork access a channel. During the beacon slots 102, specific slots are allocated to enable transmission of beacons by BN or SN. During the SCP 104, any of the devices of a subnetwork can transmit data. The SCP 104 starts immediately after the end of the beacon-slot(s) 102 of the PRIME frame 100. Collisions resulting from simultaneous attempt to access the channel are avoided by the CSMA-CA mechanisms described herein. The length of the SCP 104 may change from one frame to another and is indicated by information in the Beacon corresponding to each PRIME frame 100. However, use of the SCP 104 is not restricted to PRIME frames in which beacons are received.

The CFP 106 of PRIME frame 100 is optional and is present when a device is allocated channel time in response to an explicit request to do so. If no device on a subnetwork requests contention-free channel access, the CFP 106 may be entirely absent from the PRIME frame 100. Furthermore, a single PRIME frame may include multiple non-overlapping CFPs 106 up to an amount defined by a parameter, MACCFPMaxAlloc.

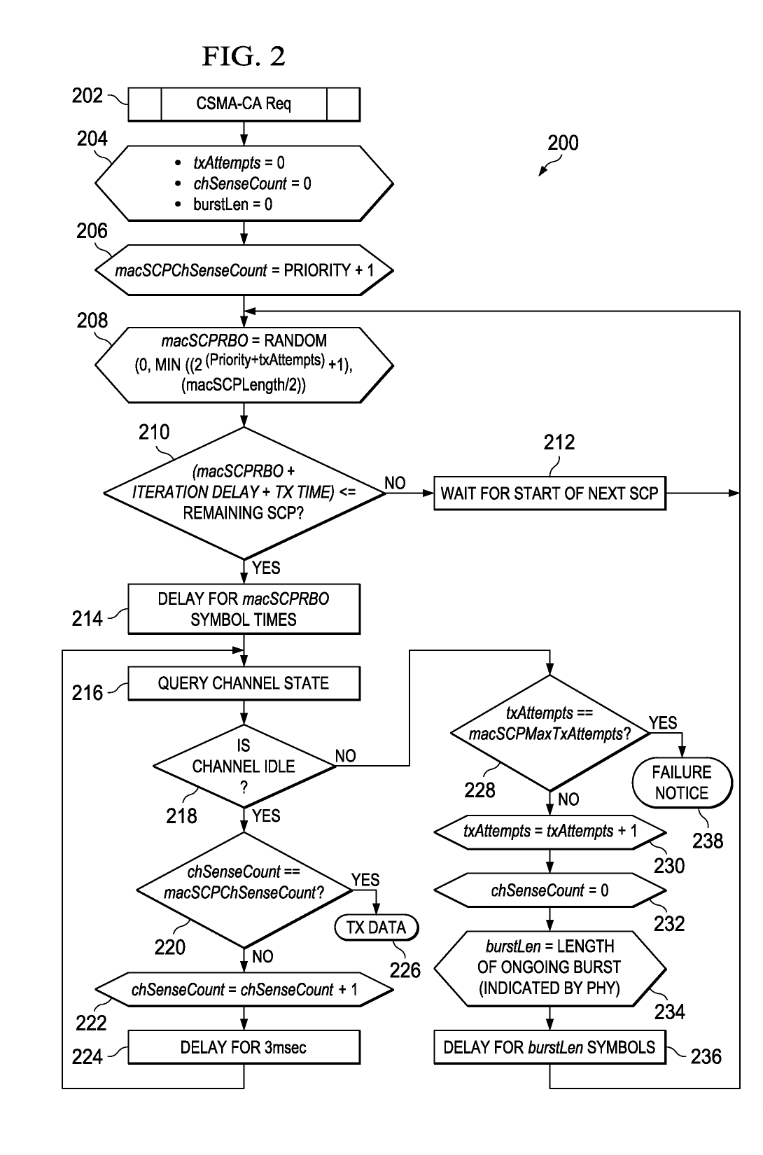

FIG. 2 shows a flowchart for a PRIME CSMA-CA algorithm 200. In FIG. 2, the CSMA-CA algorithm 200 comprises starting a CSMA-CA request (block 202) and setting parameters (e.g., txAttempts, chSenseCount, and burstLen) to a default value (e.g., zero) at block 204. At block 206, the parameter macSCPChSenseCount=Priority+1, where the Priority parameter enables devices of a subnetwork to prioritize data transmissions. For the PRIME CSMA-CA algorithm 200, MACPriorityLevels levels of priority are defined with a lower value indicating higher priority. In the case of data aggregation, the priority of aggregate bulk data is governed by the highest priority data contained therein. At block 208, the random backoff time (macSCPRBO) for a transmission attempt is given as macSCPRBO=random (0, MIN ((2^{(Priority+txAttempts)}+1), (macSCPLength/2)). Before a backoff period starts, a device should ensure that the remaining SCP time is long enough to accommodate the backoff, the number of iterations for channel-sensing (based on data priority), and the subsequent data transmission. If this is not the case (determination block 210), backoff should be aborted till the SCP starts in the next frame (block 212). Aborted backoffs that start in a subsequent frame should not carry macSCPRBO values of earlier attempts. Instead, macSCPRBO values should be regenerated on the resumption of the transmission attempt in the SCP time of the next frame.

If there is sufficient time for a backoff period (determination block 210), a delay for macSCPRBO symbol times occurs (block 214). On the completion of macSCPRBO symbol times (block 214), channel-sensing is performed by querying the channel state (block 216). If the channel is idle (determination block 218), a determination is made regarding whether data is to be transmitted (block 220) by comparing chSenseCount to macSCPChSenseCount. If chSenseCount=macSCPChSenseCount, then data is transmitted (block 226). Otherwise, the value of chSenseCount is incremented (block 222) and a delay of 3 msec occurs (block 224) before a next channel-sensing loop begins. The number of times that a communication device performs channel-sensing before transmitting data is determined by the priority of the data (macSCPChSenseCount=Priority+1). In other words, when a channel is sensed to be idle for each of macSCPChSenseCount channel-sensing loops, a communication device performing algorithm 200 concludes that the channel status is idle and carries out its transmission immediately.

If the channel is not idle (determination block 218), txAttempts is compared to macSCPMaxTxAttempts (determination block 228) to determine if a failure should be declared (block 238). More specifically, if txAttempts=macSCPMaxTxAttempts (determination block 228), a failure is declared (block 238). Otherwise, the value of txAttempts is incremented (block 230) and the value of chSenseCount is set to zero (block 232). Further, the value of burstLen is determined as the length of the ongoing burst indicated by the PHY layer (block 234) and a delay for burstLen symbols occurs (block 236) before the algorithm 200 returns to block 208 where a new macSCPRBO is generated. In other words, during any of the macSCPChSenseCount channel-sensing iterations, if the channel is sensed to be occupied, the communication device increases txAttempts and reset all other working variables. If the CSMA-CA algorithm 200 restarts macSCPMaxTxAttempts number of times due to ongoing transmissions from other devices on the channel, the communication device aborts a pending transmission by informing upper control layers that a CSMA-CA failure has occurred.

FIG. 3 shows a communication device 302 in accordance with an embodiment of the disclosure. The communication device 302 may correspond to any existing device (e.g., desktop computers, laptop computers, cellular phones and/or smart phones) configured for used in a CSMA-CA subnetwork. As shown, the communication device 302 comprises a processor 304 and a transceiver (TX/RX) 306 with a media access control (MAC) layer 308 and a PHY layer 316. The MAC layer 308 comprises CSMA/CA logic 310 for performing CSMA-CA operations. In at least some embodiments, the CSMA/CA logic 310 comprises contention window size randomization logic 312 that performs randomization as described herein. Additionally or alternatively, the CSMA/CA logic 310 comprises packet drop reduction logic 314 that causes CSMA/CA to become more conservative as described herein. The CSMA/CA logic 310 may be implemented, for example, as a processor executing software instructions. Alternatively, the CSMA/CA logic 310 may be implemented as specialized hardware (e.g., an ASIC or a programmable controller).

In operation, the contention window size randomization logic 312 causes an increase in the range of randomization for the contention window size used for CSMA-CA. The contention window size corresponds to macSCPRBO in the algorithm 200 described previously. In at least some embodiments, the contention window size randomization logic 312 operates as part of a modified PRIME CSMA-CA algorithm. In such embodiments, the contention window size randomization logic 312 increases the range of contention window size randomization by adding a variable to a linear portion of a contention window size calculation. Additionally or alternatively, the contention window size randomization logic 312 increases the range of contention window size randomization by adding a variable to an exponential portion of a contention window size calculation. In other words, the contention window size randomization logic 312 increases the range of randomization for macSCPRBO by changing the boundary used for randomization. In addition, the contention window size randomization logic 312 may randomize a channel sensing delay, which is fixed at 3 msec in algorithm 200.

In operation, the packet drop reduction logic 314 prevents adjustment of a busy channel count parameter (txAttempts) for a predetermined number of channel sense attempts. By preventing adjustment of txAttempts, the communication device 302 increases the number of times channel-sensing is performed before declaring a failure. Also, the communication device withholds the increase of macSCPRBO when preventing adjustment of txAttempts. In at least some embodiments, if a count is not added to the busy channel count parameter (txAttempts), the packet drop reduction logic 314 adds a count to a first attempt channel sense parameter (referred to herein as “txAttemtpsFirstSense”). In at least some embodiments, the packet drop reduction logic 314 causes txAttemtpsFirstSense to be compared with a predetermined value (macSCPMaxTxAttemptsFirstSense) and declares a failure is the parameter values are equal.

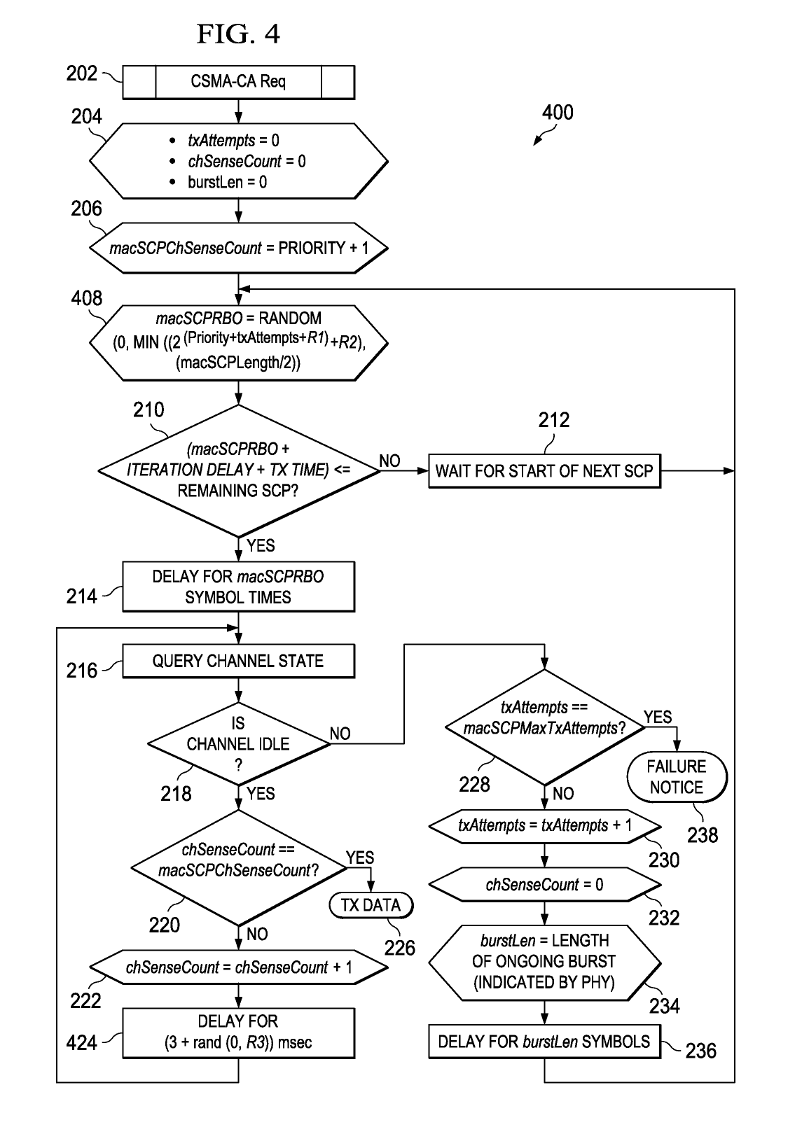

FIG. 4 shows a CSMA-CA algorithm 400 for increasing the range for randomizing a contention window size in accordance with an embodiment of the disclosure. The CSMA-CA algorithm 400 may be performed, for example, by the CSMA/CA logic 310 of communication device 302. As shown, the CSMA-CA algorithm 400 comprises various steps that are included in the PRIME CSMA-CA algorithm 200. However, the range for macSCPRBO determined at block 408 in CSMA-CA algorithm 400 is different than the range for macSCPRBO determined at block 208 in CSMA-CA algorithm 200. Instead of macSCPRBO=random (0, MIN ((2^{(Priority+txAttempts)}1), (macSCPLength/2)) as in CSMA-CA algorithm 200, block 408 determines macSCPRBO as random (0, MIN ((2^{(Priority+txAttempts+R1)}R2), (macSCPLength/2)). In other words, a variable (R1) has been added to an exponential portion of the contention window size calculation in block 408. Also, a variable (R2) has been added to a linear portion of the contention window size calculation in block 408. In algorithm 400, the channel sense delay determined at block 424 may also be randomized instead of being fixed as in algorithm 200. For example, the randomization may be accomplished by adding a variable (R3) to the channel sense delay determination such that the delay=(3+rand (0, R3)) msec.

As an example, in the PRIME algorithm 200, the contention window size would be 2^{Priority+txAttempts}+1, which is only 2 when both priority and txAtttempts equal zero. The PRIME algorithm 200 will also produce small contention window size values for the next few trials (e.g., 3, 5, 9, and so on when txAttempts increases to 1, 2, 3, and so on). In contrast, the algorithm 400 produces an initial contention window size of 2^{Priority+txAttempts+R1}+R2, so that even if both priority and txAttempts equal zero, the contention window size is 2^{R1}+R2. In accordance with at least some embodiments, both R1 and R2 are integers and can be configured based on the network density. In a dense network, R1 and R2 would be set to be a bigger value. The proper selection of R1 and R2 guarantees that the initial contention window size value is large enough so that nodes in the same transmission scope avoid transmission collisions during their first few trials when the contention window size is limited. Another randomness factor, R3, is added for the channel sensing delay. Use of R3 ensures that even if two nodes have selected the same contention backoff value macSCPRBO, and the two nodes send packets with the same priority, their next round of channel-sensing can be distributed so that the two nodes avoid transmitting at the same time. The added randomness factors described herein (R1, R2 and R3) are all dynamically configurable, so that a node (e.g., communication device 302) can configure these factors based on the current network congestion level. In at least some embodiments, the network congestion level is determined based on network density (the number of nodes in the network) and/or traffic levels.

Irrespective of the CSMA mechanism used, collisions are inevitable in large networks. With the PRIME algorithm 200, after every failed channel access attempt, each node increments its txAttempts as well as its contention window backoff value macSCPRBO for its next channel sensing trial. With a macSCPRBO value that is larger than other nodes, during the next CSMA competition opportunity, a given node may have to back off longer than the other nodes that have just started their first trial. In such case, this given node will find the medium is busy while it senses the medium. After several channel-sensing trials like this, txAttempts will reach the maximum allowed value, and the given node drops the pending packets and reports a CSMA failure. As observed in lab tests and simulations, the CSMA failure rate becomes more severe when adding more nodes and traffic into the network, creating more channel access competitions during the SCP period. For example, simulations shows that even for a moderate number of nodes (e.g., 10 nodes) with moderate traffic (e.g., keep-alive messages every 4 seconds) as many as 10% of packets get dropped due to reaching the CSMA maximum trials. As network nodes increase and/or traffic increases, the PRIME algorithm 200 operates too aggressively, causing packets to be dropped pre-maturely.

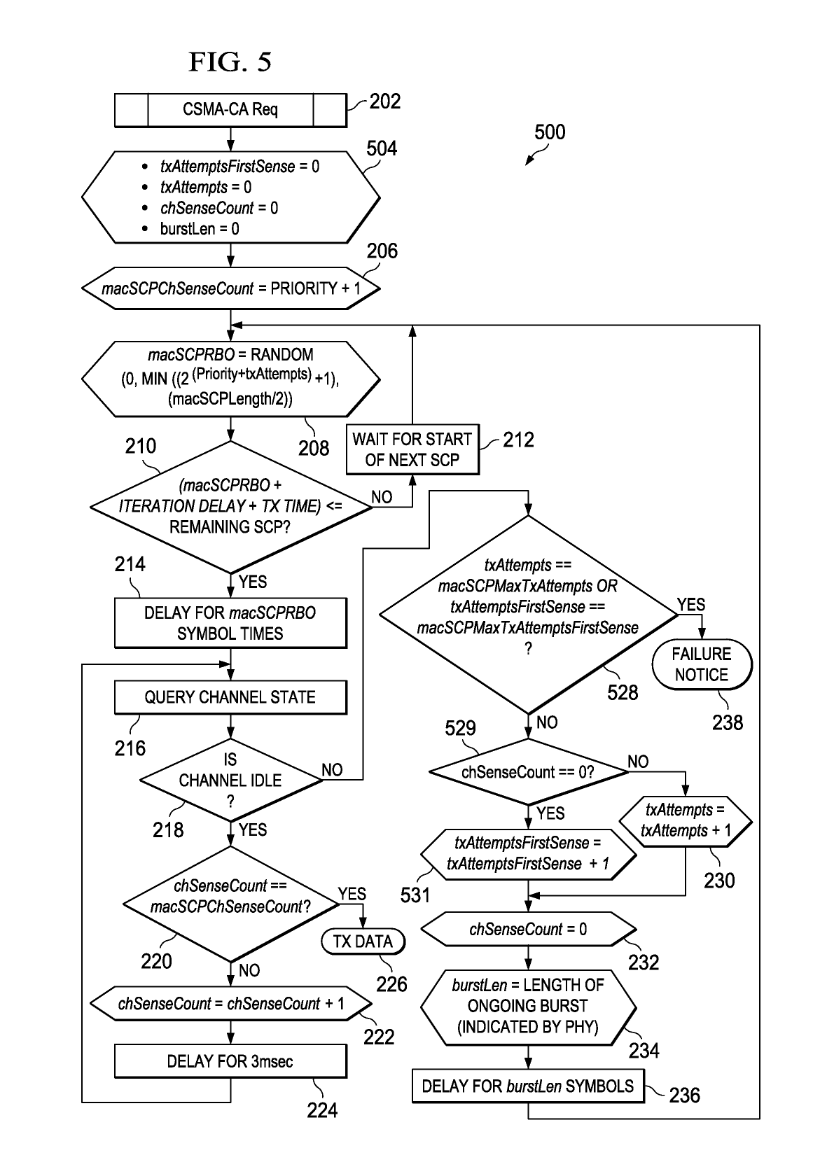

FIG. 5 shows a CSMA-CA algorithm 500 for reducing dropped packets in accordance with an embodiment of the disclosure. The CSMA-CA algorithm 500 may be performed, for example, by the CSMA/CA logic 310 of communication device 302. As shown, the CSMA-CA algorithm 500 comprises various steps that are included in the PRIME CSMA-CA algorithm 200. In the algorithm 500, a parameter txAttemptsFirstSense is utilized to change the criteria for determining a CSMA-CA failure and thereby to reduce dropped packets. As shown, the algorithm 500 selectively prevents incrementing txAttempts and, instead, increments txAttemptsFirstSense using blocks 529 and 531. More specifically, block 529 compares chSenseCount to a predetermined value (zero or another value). If chSenseCount equals or is less than the predetermined value (determination block 529), txAttemptsFirstSense is incremented instead of txAttempts. Otherwise, txAttempts is incremented (block 230). In algorithm 500, block 528 determines whether to assert a CSMA-CA failure notification (block 238) based on two possible criteria. One criteria for determining a CSMA-CA failure is the same as is algorithm 200 (if txAttempts=macSCPMaxTxAttempts). The other criteria for determining a CSMA-CA failure is based on the value of txAttemptsFirstSense (if txAttemptsFirstSense=macSCPMaxTxAttemptsFirstSense, a failure occurs).

The difference between the conservative CSMA-CA algorithm 500 and the PRIME algorithm 200 is described herein. Each round of carrier-sensing in the PRIME algorithm 200 is composed of a set of mini carrier-sensing queries (a total chSenseCount times). In the CSMA-CA algorithm 500, the first mini-query is separated from the other following mini-querys. If the node finds the medium busy during its first channel query after random backoff, the node does not increase txAtttempts nor the next contention window size. This is because node implementing CSMA-CA algorithm 500 can be considered to have not tried to transmit anything yet and has not caused any potential competition in the medium yet, so the node simply waits for the current frame to finish and tries again using the same contention window size. The txAttempts value will only increase when the second or further channel query returns busy.

Simulations have been run for several different scenarios. In these simulations, macSCPMaxTxAttemptsFirstSense has been set as a large number (approaching infinity), so all the CSMA failures shown here are due to txAttempts reaching macSCPMaxTxAttempts, which has a default value of 5. As shown in Table 1, the CSMA-CA algorithm 500 can improve the CSMA failure rate compared to the original PRIME algorithm 200 by about 2.5 to 5.0 times for different networks with moderate density and traffic loads.

TABLE 1

| | CSMA req | CSMA drop | drop/req |
|---|---|---|---|
| | 9 nodes | | |
| Orig PRIME | 4,454 | 273 | 6.13% |
| Optimization | 4,495 | 59 | 1.31% |
| | 19 nodes | | |
| Orig PRIME | 9391 | 850 | 9.05% |
| Optimization | 9432 | 354 | 3.75% |
| | 29 nodes | | |
| Orig PRIME | 14237 | 1470 | 10.33% |
| Optimization | 14370 | 588 | 4.09% |

Though the results of Table 1 are based on macSCPMaxTxAttemptsFirstSense being set to infinity, the value for macSCPMaxTxAttemptsFirstSense could alternatively be set to a large number to achieve similar results. To summarize, the CSMA-CA algorithm 400 improves performance of CSMA compared to PRIME algorithm 200 by increasing the range of the random backoff to avoid collisions. Further, the CSMA-CA algorithm 500 improves performance of CSMA compared to PRIME algorithm 200 by modifying the CSMA “score-keeping” to ensure nodes do not declare failure or increase the random backoff window size after just a few channel access attempts. The CSMA-CA algorithms 400 and 500 described herein may or may not be combined.

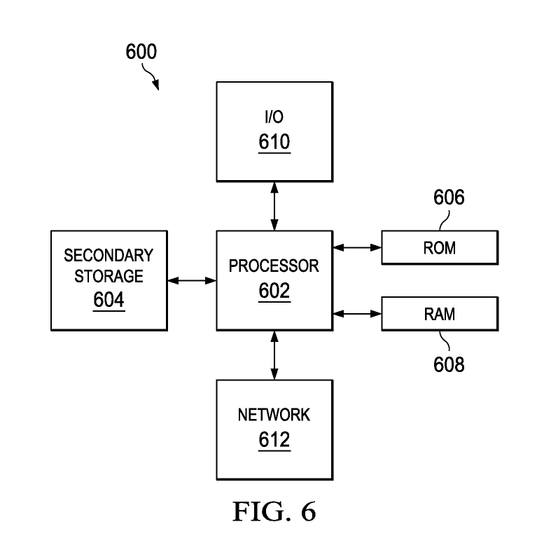

The CSMA-CA techniques describes herein may be implemented on any general-purpose network component, such as a computer or network component with sufficient processing power, memory resources, and network throughput capability to handle the necessary workload placed upon it. FIG. 6 illustrates a typical, general-purpose computer system 600 suitable for implementing one or more embodiments of the components disclosed herein. The computer system 600 includes a processor 602 (which may be referred to as a central processing unit (CPU)) that is in communication with memory devices including secondary storage 604, read only memory (ROM) 606, random access memory (RAM) 608, input/output (I/O) devices 610, and network connectivity devices 612. The processor 602 may be implemented as one or more CPU chips, or may be part of one or more application specific integrated circuits (ASICs).

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage. The RAM 608 is used to store volatile data and perhaps to store instructions. Access to both ROM 606 and RAM 608 is typically faster than to secondary storage 604.

In at least some embodiments, the secondary storage 604, RAM 608 and/or ROM 606 correspond to a computer-readable storage medium that stores instructions for performing the CSMA-CA algorithms 400 and 500 described herein. When executed (e.g., by processor 602), the instructions cause a processor to selectively increase a range for randomization of a contention window size. For example, the instructions may increase the range for randomization of the contention window size by adding a variable to a linear portion (R2) and/or an exponential portion (R1) of a contention window size calculation. The instruction, when executed, may further cause a processor to randomize a channel sensing delay for CSMA-CA by adding a variable (R3). The instructions, when executed, may further cause a processor to prevent adjustment of a busy channel count parameter (txAttempts) for a predetermined number of channel sense attempts. For example, the instructions may cause the processor to add a count to a first attempt channel sense parameter (txAttemptsFirstSense) instead of the busy channel count parameter (txAttempts).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A communication device, comprising:
a transceiver with Carrier Sensing Multiple Access with Collision Avoidance (CSMA-CA) logic that provides dynamic randomization management for a contention window size.

2. The communication device of claim 1 wherein the CSMA-CA logic randomizes a channel sensing delay.

3. The communication device of claim 1 wherein the CSMA-CA logic prevents adjustment of a busy channel count parameter for a predetermined number of channel sense attempts.

4. The communication device of claim 3 wherein, if a count is not added to the busy channel count parameter, the CSMA-CA logic adds a count to a first attempt channel sense parameter.

5. The communication device of claim 1 wherein the CSMA-CA logic determines a network congestion state and adjusts a range for randomization of the contention window size as part of a Powerline-Related Intelligent Metering Evolution (PRIME) algorithm.

6. The communication device of claim 1 wherein the CSMA-CA logic selectively increases a range for randomization of the contention window size by adding a variable to a linear portion of a contention window size calculation.

7. The communication device of claim 1 wherein the CSMA-CA logic selectively increases a range for randomization of the contention window size by adding a variable to an exponential portion of a contention window size calculation.

8. A computer-readable storage medium having instructions that, when executed, cause a processor to:
determine a network congestion state; and
dynamically provide randomization management for a contention window size for Carrier Sensing Multiple Access with Collision Avoidance (CSMA-CA) based on the determined network congestion state.

9. The computer-readable storage medium of claim 8 wherein the instructions, when executed, further cause the processor to randomize a channel sensing delay for CSMA-CA.

10. The computer-readable storage medium of claim 8 wherein the instructions, when executed, cause the processor to prevent adjustment of a busy channel count parameter for a predetermined number of channel sense attempts.

11. The computer-readable storage medium of claim 10 wherein the instructions, when executed, further cause the processor to add a count to a first attempt channel sense parameter instead of the busy channel count parameter.

12. The computer-readable storage medium of claim 8 wherein the instructions, when executed, cause the processor to increase a range for randomization of the contention window size as part of a Powerline-Related Intelligent Metering Evolution (PRIME) algorithm.

13. The computer-readable storage medium of claim 8 wherein the instructions, when executed, cause the processor to increase a range for randomization of the contention window size by adding a variable to a linear portion of a contention window size calculation.

14. The computer-readable storage medium of claim 8 wherein the instructions, when executed, cause the processor to increase a range for randomization of the contention window size by adding a variable to an exponential portion of a contention window size calculation.

15. A method for Carrier Sensing Multiple Access with Collision Avoidance (CSMA-CA), comprising:
determining a network congestion state; and
adjust, by a processor, a range for randomization of a contention window size for CSMA-CA based on the determined network congestion state.

16. The method of claim 15 further comprising randomizing a channel sensing delay for multiple channel state queries performed during CSMA-CA.

17. The method of claim 15 further comprising preventing adjustment of a busy channel count parameter for a predetermined number of channel sense attempts.

18. The method of claim 17 further comprising determining if a count is to be added to a first attempt channel sense parameter or to the busy channel count parameter.

19. The method of claim 15 further comprising dynamically determining a network density and adjusting said range for randomization of the contention window size based on said network density determination.

20. The method of claim 15 further comprising dynamically determining a traffic state and adjusting said range for randomization of the contention window size based on said traffic state determination.
